(19) United States
(12) Patent Application Publication
(10) Pub. No.: US 2026/0247146 A1
(43) Pub. Date: Aug. 20, 2026

(54) AUTHENTICATION SYSTEM AND METHOD, AND SERVICE SERVER FOR PROVIDING AUTHENTICATION SERVICE

(71) Applicant: Delimit Inc, Seoul (KR)

(72) Inventors: Yongjin KIM, Seoul (KR); Seongchan LIM, Seoul (KR)

(21) Appl. No.: 19/161,771

(22) PCT Filed: Mar. 8, 2024
(86) PCT No.: PCT/KR2024/003005

§ 371 Date: Sep. 3, 2025

(30) Foreign Application Priority Data
Mar. 9, 2023 (KR) 10-2023-0031299

(51) Int. Cl. H04W 12/06; H04W 12/08

(52) U.S. Cl. CPC H04W 12/06; H04W 12/08

(57) ABSTRACT

The present invention relates to an authentication system and method. As an authentication method of a system, the method may comprise receiving a call log-in request from a user terminal, transmitting a call log-in phone number to the user terminal, receiving an outgoing call from the user terminal using the call log-in phone number to establish a call connection, and requesting log-in processing for the user terminal when the received call log-in phone number matches the transmitted call log-in phone number.

According to the present invention, complex log-in procedures upon accessing a website are eliminated, and authentication service costs caused by loss of IDs and passwords can be reduced. Furthermore, by allowing content to be used only in a state where a call connection is maintained, abnormal use by others can be prevented, and a security level can be enhanced.

### CROSS-REFERENCE TO RELATED APPLICATION

This application claims priority to and the benefit of Korean Patent Application No. 10-2023-0031299 filed with the Korean Intellectual Property Office on Mar. 9, 2023, the entire contents of which are incorporated herein by reference.

### BACKGROUND OF THE INVENTION

### (a) Field of the Invention

The present disclosure relates to an authentication system and method, and a service server that provides an authentication service, and more specifically, to a system and method, and a service server for enabling a website login by using the telephone number of a user terminal connected via a telephone call.

### (b) Description of the Related Art

With the popularization of smartphones, the use of web content through mobile devices as well as PCs is increasing. In this case, a web page provided by an enterprise often requires member registration in order to provide specialized information and services.

Generally, for member registration, a user is required to enter personal information on a website and register an ID and a password, and thereafter, upon each access to the website, the user must remember the registered ID and password to proceed with the login procedure, but there has been an inconvenience in proceeding with the member registration and login procedure in a mobile environment.

In addition, despite that there are cases where the purpose of visiting a website is to provide or acquire sensitive information such as financial information, while on the other hand, there are also cases that are merely a one-time use for simple information, there was the inconvenience of all websites uniformly requiring a user to create a login ID and password through member registration by entering personal information, and recognizing the corresponding user through a login procedure by inputting the ID/password.

In this case, the user had the burden of having to proceed with a membership registration process for not visiting frequently or for a one-time provision or use of simple information, and had difficulty remembering the ID and password.

Recently, when an ID and a password are set upon accessing a specific site, a service is also provided that saves the corresponding ID and password in a browser and automatically performs a login when the site is accessed.

However, even in this case, the membership registration process including entering personal information and creating an ID and password still exists, and there was a problem in that the configured auto-login function could not be used when changing the terminal being used or using a different browser.

### SUMMARY OF THE INVENTION

### Technical Problem

Accordingly, the technical problem to be solved by the present invention is to enable simple website login using a phone number of a user terminal connected via a telephone call.

### Technical Solution

An authentication method according to an aspect of the present invention for solving the above technical problem, as an authentication method of a system, may comprise: receiving a call-login request from a user terminal; transmitting a call-login phone number to the user terminal; and receiving an outgoing call from the user terminal using the call-login phone number to establish a call connection, and when the received call-login phone number matches the transmitted call-login phone number, requesting login processing for the user terminal.

In this case, the method may further comprise verifying a membership status based on the phone number of the user terminal after the request for login processing, and providing a member page to the user terminal if the user is a member.

In addition, if the result of the membership verification for the request for login processing indicates that the user is not a member, the method may further comprise generating a user ID based on the phone number of the user terminal and processing membership registration.

In addition, after the request for login processing, when the call connection is terminated, the method may further comprise requesting logout processing for the user terminal.

Furthermore, the method may further comprise: after the call connection, guiding the user terminal to input additional authentication information; and authenticating by comparing the authentication information input from the user terminal with pre-stored authentication information for each user.

In addition, as an authentication method of a system, the method may comprise: receiving a call-login request together with a phone number of a user terminal; originating a call to the user terminal using the phone number to establish a call connection; and requesting login processing for the user terminal.

In this case, the method may further comprise verifying a membership status based on the phone number of the user terminal after the request for login processing, and providing a member page to the user terminal if the user is a member.

In addition, if the result of the membership verification for the request for login processing indicates that the user is not a member, the method may further comprise generating a user ID based on the phone number of the user terminal and processing membership registration.

Furthermore, after the request for login processing, when the call connection is terminated, the method may further comprise requesting logout processing for the user terminal.

In addition, the method may further comprise: after the call connection, guiding the user terminal to input additional authentication information; and authenticating by comparing the authentication information input from the user terminal with pre-stored authentication information for each user.

In addition, an authentication method of a system, the method may comprise: receiving a call-login request from a PC; transmitting a call-login phone number to the PC; and receiving an outgoing call from a user terminal using the call-login phone number to establish a call connection, and when the received call-login phone number matches the transmitted call-login phone number, requesting login processing for the PC.

Furthermore, after the request for login processing, when the call connection is terminated, the method may further comprise requesting logout processing for the PC.

In this case, the method may further comprise: after the call connection, guiding the user terminal to input additional authentication information; and authenticating by comparing the authentication information input from the user terminal with pre-stored authentication information for each user.

Furthermore, the method may further comprise: providing mobile access guidance to the user terminal after the call connection; and requesting mobile access login processing for the user terminal when mobile access is selected by the user terminal and the received call-login phone number matches the call-login phone number.

In this case, after the request for mobile access login processing, when the call connection is terminated, the method may further comprise requesting logout processing for the user terminal.

In addition, an authentication method of a system, the method may comprise: receiving an outgoing call using a pre-issued call-login phone number from a user terminal to establish a call connection; and requesting login processing for the user terminal when the received call-login phone number matches the pre-issued and registered call-login phone number.

In this case, after the request for login processing, when the call connection is terminated, the method may further comprise requesting logout processing for the user terminal.

An authentication system according to an aspect of the present invention for solving the above technical problem may comprise: a call system configured to receive an outgoing call from a user terminal using a call-login phone number to establish a call connection with the user terminal, and transmit a phone number of the user terminal and the call-login phone number to a service server; and a service server configured to generate a call-login phone number and transmit the call-login phone number to the user terminal upon a call-login request from the user terminal, and request login processing for the user terminal when the call-login phone number received from the call system matches the call-login phone number transmitted to the user terminal.

In this case, if the user is not a member as a result of verification regarding the request for login processing, the service server may generate a user ID based on the phone number of the user terminal and process membership registration.

In addition, the service server may request logout processing for the user terminal when the call connection is terminated.

Further, when the call system receives an outgoing call using a call-login phone number in a specific range from the user terminal, the call system may guide input of additional authentication information and receive additional authentication information from the user terminal, and the service server may authenticate by comparing the additional authentication information transferred from the call system with pre-stored authentication information for each user.

In addition, as an authentication system, the system may comprise: a call system configured to originate a call to a phone number of a user terminal transferred from a service server, and transmit the phone number of the user terminal upon a call connection; and a service server configured to request the call system to originate a call to the user terminal, and request login processing for the user terminal upon the call connection.

In this case, the service server may request logout processing for the user terminal when the call connection is terminated after the request for login processing.

Further, an authentication system, the system may comprise: a call system configured to receive an outgoing call from a user terminal using a call-login phone number to establish a call connection with the user terminal, and transmit a phone number of the user terminal and the call-login phone number to a service server; and a service server configured to generate a call-login phone number and transmit the call-login phone number to a PC upon a call-login request using the PC, and request login processing for the PC when the call-login phone number received from the call system matches the call-login phone number transmitted to the PC.

In addition, the service server may request logout processing for the PC when the call connection is terminated. 1

In this case, the call system provides mobile access guidance to the user terminal after the call connection, and the service server may request login processing for the user terminal when receiving a mobile access selection from the call system. In addition, the service server may request logout processing for the user terminal when the call connection is terminated. 1

A service server according to an aspect of the present invention for solving the above technical problem, as a service server providing an authentication service using a user terminal, may comprise: an authentication unit configured to generate a call-login phone number and transmit the call-login phone number to the user terminal upon a call-login request, enabling the user terminal to originate a call to the call-login phone number; and a service management unit configured to request login processing for the user terminal when a call connection is established via an outgoing call of the user terminal and a received call-login phone number matches the call-login phone number transmitted by the authentication unit, and request logout processing for the user terminal when the call connection is terminated.

In this case, if the user is not a member as a result of the request for login processing, the service management unit may generate a user ID based on the phone number of the user terminal and process membership registration.

In this case, the authentication unit transmits the call-login phone number to the PC when the call-login request is received via a user PC, and the service management unit requests login processing for the PC when a call connection is established via an outgoing call of the user terminal and a received call-login phone number matches the call-login phone number transmitted by the authentication unit, and may request logout processing for the PC when the call connection with the user terminal is terminated.

In addition, the service management unit may request login processing for the user terminal when a call connection is established via an outgoing call of the user terminal, a received call-login phone number matches the call-login phone number transmitted by the authentication unit, and a mobile access selection of the user terminal is received; and may request logout processing for the user terminal when the call connection with the user terminal is terminated.

In addition, a service server according to an aspect of the present invention, as a service server providing an authentication service using a user terminal, may comprise: an authentication unit configured to receive a call-login request together with a phone number of the user terminal, and cause a call to be originated to the phone number of the user terminal to establish a call connection; and a service management unit configured to request login processing for the user terminal upon the call connection, and request logout processing for the user terminal when the call connection is terminated.

### Advantageous Effects

As described above, according to the present invention, complicated login procedures upon accessing a website are eliminated, and membership registration becomes possible without generating an ID and a password.

In addition, authentication service costs arising from the loss of IDs and passwords can be reduced.

Furthermore, by enabling the use of content only while the call connection is maintained, abnormal use by others can be prevented, and the security level can be enhanced.

### BRIEF DESCRIPTION OF THE DRAWINGS

FIG. 1 illustrates the overall service structure comprising an authentication system according to an aspect of the present invention.

FIG. 2 is a block diagram of a call system according to an aspect of the present invention.

FIG. 3 is a block diagram of a service server according to an aspect of the present invention.

FIG. 4 explains a flow in which a user logs into a corresponding site via an outgoing call after accessing a website intended to be used through a mobile terminal, according to an aspect of the present invention.

FIG. 5 explains a flow in which a user logs into a corresponding site by receiving a call after accessing a website intended to be used through a mobile terminal, according to an aspect of the present invention.

FIG. 6 explains a flow in which a user logs into a corresponding site through a PC by authenticating via an outgoing call after accessing a website through the PC, according to an aspect of the present invention.

FIG. 7 explains a flow in which a user authenticates via an outgoing call after accessing a website through a PC and logs in through mobile access, according to an aspect of the present invention.

FIG. 8 explains a flow in which a user authenticates by directly originating a call to a pre-given number via a mobile terminal and logs into a desired site, according to an aspect of the present invention.

FIG. 9 explains a flow in which a user authenticates and accesses a website by receiving a call originated at the request of a content providing company, according to an aspect of the present invention.

### DETAILED DESCRIPTION OF THE EMBODIMENTS

In the following detailed description, only certain embodiments of the present invention have been shown and described, simply by way of illustration. However, the present invention may be implemented in various different forms and is not limited to the embodiments described herein. Accordingly, the drawings and description are to be regarded as illustrative in nature and not restrictive. Like reference numerals designate like elements throughout the specification.

Throughout the entire specification, when a part “includes” a component, this means that it may further include other components, not that it excludes other components, unless there is a specific statement to the contrary.

In addition, the terms such as “. . . unit” , “. . . part” , “. . . module” , etc., as described in the specification, mean a unit that processes at least one function or operation, and this may be implemented by hardware or software or a combination of hardware and software.

The apparatuses described in the present invention are composed of hardware comprising at least one processor, a memory device, a communication device, and the like, and a program that is executed in combination with the hardware is stored in a specified location. The hardware has a configuration and performance capable of executing the method of the present invention. The program comprises instructions for implementing the operating method of the present invention described with reference to the drawings, and executes the present invention in combination with hardware such as a processor and a memory device.

In this specification, “transmission or provision” may include not only direct transmission or provision but also indirect transmission or provision through another device or by using a bypass path.

In this specification, an expression recited in the singular, unless an explicit expression such as “one” or “single” is used, may be interpreted as singular or plural.

In the present specification, the same reference numerals refer to the same components regardless of the drawings, and “and/or” includes each of the mentioned components and all combinations of one or more thereof.

In this specification, terms including ordinal numbers, such as first, second, etc., may be used to describe various constituent elements, but the constituent elements are not limited by the terms. The terms are used only for the purpose of distinguishing one element from another element. For example, without departing from the scope of the present disclosure, a first component may be named a second component, and similarly, the second component may also be named the first component.

In the flowcharts described in this specification with reference to the drawings, the order of operations may be changed, multiple operations may be combined, an operation may be divided, and a specific operation may not be performed.

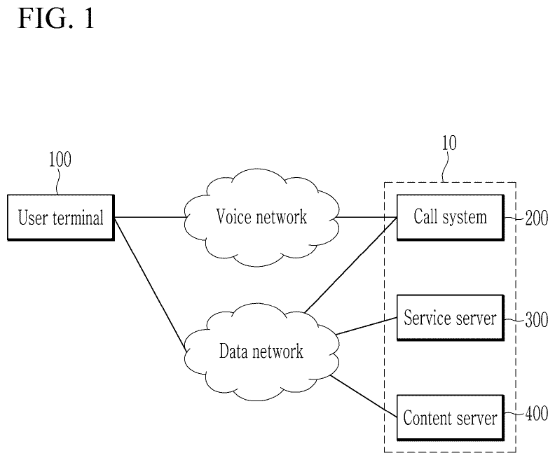

First, referring to FIG. 1, the overall service structure of an authentication system 10 according to an aspect of the present invention will be described.

The user terminal 100 is a terminal such as a smartphone, and includes a terminal including a telephone function and a computing function.

The user terminal 100 may access a content server 400 providing target content, and may originate a call to a call system 200 using a phone number provided for login (hereinafter referred to as a “call-login phone number”). Alternatively, the user terminal 100 may receive a call originated via the call system 200, and input additionally required authentication information according to guidance. Through the user terminal 100, for example, a preset password may be input as additional authentication information, or voice information for speaker recognition may be input.

When authentication is completed by the service server 300, the user terminal 100 may access a web page provided by the content server 400 and use content in a state where a call connection is established with the call system 200 via call reception or origination.

Recently, as the user terminal 100 such as a smartphone is diversely used for purposes such as identity verification, credit information inquiry, and payment means, many users are using a locking function of the smartphone. In addition, due to the development of biometric authentication methods, various biometric authentication methods such as fingerprints, irises, and faces are being utilized for smartphone locking functions, and thus, the use of smartphones by others is becoming increasingly difficult.

Therefore, according to the present invention, a phone number assigned to the user terminal 100, such as a smartphone, is utilized as a unique ID of a user to perform authentication, and login processing is enabled at a website desired by the user.

The authentication system 10 comprises a call system 200, a service server 300, and a content server 400, and may authenticate a user by utilizing a phone number assigned to the user terminal 100 and enable login processing to be performed at a website intended to be used.

The call system 200 may receive an outgoing call of the user terminal 100 accessing the content server 400, or may originate a call to the user terminal 100 via a phone number transmitted from the service server 300.

The call system 200 may transmit authentication guidance to the user terminal 100 when there is a request for additional authentication, and may transmit authentication information received from the user terminal 100 to the service server 300.

The call system 200 is connected to the user terminal 100 via a line, and when a call with the user is terminated while the user is accessing a webpage and using content, the call system 200 transmits the call termination to the service server 300 to cause the user to be processed for logout at the content server 400.

The service server 300 may generate a call-login phone number according to a user request and provide it to the user terminal 100, or may provide a pre-generated call-login phone number to the user terminal 100. If the content to be used is a subject for additional authentication, a request for additional authentication is confirmed, and the call system 200 may be caused to provide authentication guidance to the user terminal 100. At this time, the user may be asked via the call system 200 whether to perform additional authentication, and the call system 200 may be caused to provide additional authentication guidance to the user terminal only if the user desires.

The service server 300 may determine whether to authenticate by comparing the additional authentication information transmitted from the call system 200 with pre-stored authentication information.

The service server 300 may confirm the identity of the call-login number transmitted from the call system 200 and the issued call-login number, and if they are identical, transmit access information including a phone number and/or an IP address of the corresponding user terminal 100 to the content server 400 to cause the content server 400 to process a login of the corresponding user terminal 100.

In addition, when the service server 300 receives a call termination from the call system 200, the service server 300 may transmit access information including a phone number and/or an IP address of the corresponding user terminal 100 to the content server 400 to cause logout processing.

The content server 400 provides a web page that a user intends to use by accessing it, and may provide a “Call-Login” selection menu as a method of accessing using a phone call among login methods provided by the website.

The content server 400 may perform login processing for the user terminal 100 for which a phone number matching or additional authentication procedure has been completed by the service server 300.

At this time, the content server 400 may verify membership status based on the received number of the user terminal 100, and perform login processing for a user who is already registered as a member.

In addition, if the user is not a member, the content server 400 may generate a user ID based on the received number of the user terminal 100 and proceed with membership registration through only a basic consent procedure for service terms, or may proceed with membership registration by causing a user ID based on the phone number of the user terminal to be generated by the service server 300.

In addition, when the content server 400 receives a request for service suspension due to the termination of a call between the call system 200 and the user terminal 100 from the service server 300, the content server 400 may execute a logout based on access information including a phone number and/or an IP address of the corresponding user terminal 100.

The content server 400 may request execution of a login service using a phone call (hereinafter, “Call-Login Service”) while first transmitting the phone number of the user terminal 100 to the service server 300.

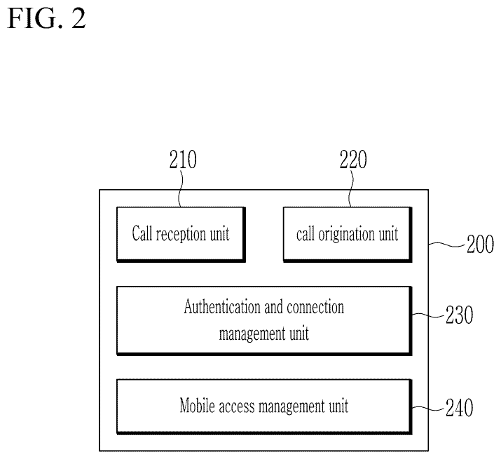

Hereinafter, the call system 200 according to an aspect of the present invention will be described in more detail with reference to FIG. 2.

The call system 200 may comprise a call reception unit 210, a call origination unit 220, an authentication and connection management unit 230, and a mobile access management unit 240.

The call reception unit 210 may receive a call originated by the user terminal 100 using a call-login phone number generated and transmitted by the service server 300.

The call origination unit 220 may originate a call to the transmitted number of the user terminal 100 when there is a call origination request by the service server 300.

The authentication and connection management unit 230 may transmit the terminal phone number of the user terminal 100 and the received call-login phone number to the service server 300.

In addition, the authentication and connection management unit 230 may provide authentication guidance for additional authentication other than the phone number when additional authentication is required, such as a case where target content includes sensitive information. For example, the authentication and connection management unit 230 may request an input of a preset password or an input of voice information for speaker recognition. Further, the authentication and connection management unit 230 may transmit the received authentication information to the service server 300.

In addition, when a call with the user terminal 100 is terminated, the authentication and connection management unit 230 may transmit the call termination together with the user phone number to the service server 300.

The mobile access management unit 240 may provide guidance on accessing a mobile website when a user accesses a website through a PC, requests a call-login service, receives a call-login phone number generated by the service server 300 via the PC, and makes a call using the user terminal 100. The mobile access management unit 240 may request mobile access to the service server 300 when the user selects mobile access instead of a PC.

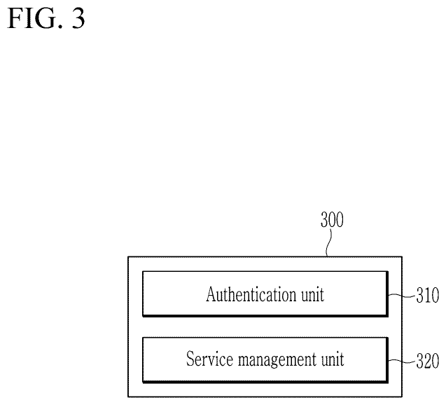

FIG. 3 is a block diagram of the service server 300 according to an aspect of the present invention. The service server 300 may comprise an authentication unit 310 and a service management unit 320.

When receiving a request for a call-login service, the authentication unit 310 may generate and transmit a call-login phone number to the user terminal 100 or manage and transmit a pre-issued call-login phone number, and may transmit the phone number of the user terminal 100 to the call system 200 and request call origination.

The authentication unit 310 may randomly generate a call-login phone number, verify whether the call-login phone number received from the call system 200, after the user terminal 100 establishes a call connection with the call system 200 through the corresponding phone number, matches the call-login phone number generated by the call-login service request, verify whether it matches a user who accessed a specific website and requested the call-login service, and identify the user of the corresponding website. Through this, the phone number of the user terminal 100 used by the corresponding website user to make a call can be verified, and the verified phone number of the user terminal 100 is used as a user ID of the corresponding website, thereby enabling a login process to be performed based on the phone number of the corresponding website user.

In this case, the authentication unit 310 may check a time interval between a time point of generating the call-login number and a time point of actual calling to the corresponding call-login number by the user terminal 100 at a time of verifying the user, and may proceed with a procedure for the call-login only when the time interval is within a preset time. When the time interval exceeds the preset time, guidance indicating service unavailability may be transmitted by the call system 200, or a re-request for the call-login service may be performed.

The authentication unit 310 may cause the call system 200 to provide guidance for additional authentication when there is a request for additional authentication, and may perform an additional authentication procedure by comparing additional authentication information transmitted through the call system 200 with pre-stored authentication information. Alternatively, when additional authentication is required, the authentication unit 310 may generate a call-login number of a specific range and cause the call system 200 to provide guidance for inputting additional authentication information.

The service management unit 320 may execute a login request for the verified user terminal 100 to the content server 400, and when receiving a notice of call termination with the user terminal 100 from the call system 320, may transmit access information including a phone number and/or an IP address of the corresponding user terminal 100 to the content server 400 to request a logout.

In addition, the service management unit 320 may cause guidance for mobile access to be provided to a user who has requested a call-login through a PC, and may request a login for mobile access using the user terminal 100 when mobile access is requested.

In addition, if necessary, the service management unit 320 may automatically generate a user ID based on the phone number of the user terminal 100 verified by the call from the user terminal 100, perform member registration for the user by receiving only consent to basic service terms from the user terminal 100, and register authentication information such as a password or voice information of each user when additional authentication is required.

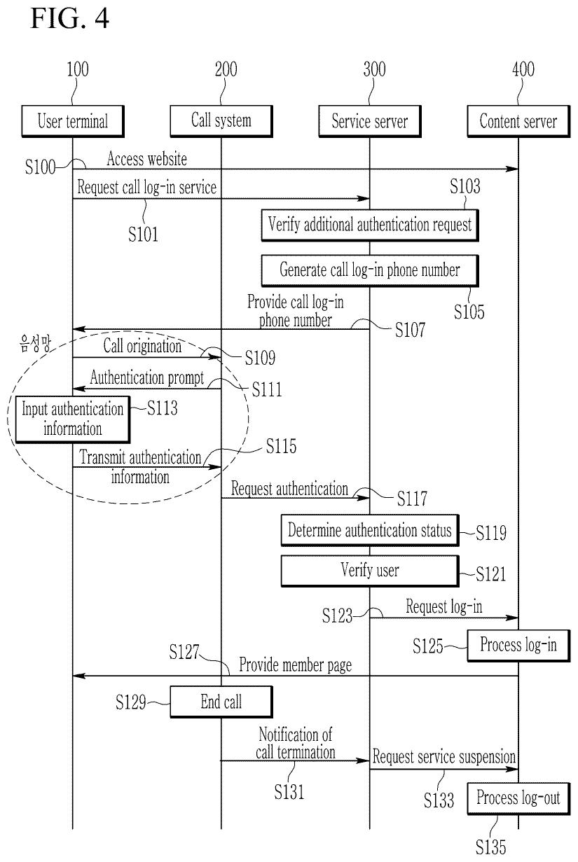

Hereinafter, embodiments according to an aspect of the present invention will be described in detail with reference to FIGS. 4 to 9.

FIG. 4 describes, as an embodiment, a method in which a user accesses a website provided by the content server 400 through the user terminal 100, which is a mobile terminal, and then logs in to the corresponding site through call origination to a call-login phone number from the user terminal 100.

First, the user terminal 100 may access a website provided by the content server 400 (S100).

The content server 400 may provide a “Call-Login” menu, which is a login method using a phone call. When the call-login menu is selected through the user terminal 100, the user terminal 100 requests a call-login service from the service server 300, and in this case, may transmit access information capable of identifying the user terminal 100, such as an IP address and a parameter, together therewith (S101). Alternatively, when the user terminal 100 accesses the website, the content server 400 may immediately request the call-login service from the service server 300. In this case, even if the user does not separately select the call-login menu, the content server 400 may request the call-login service simultaneously with the user terminal 100 accessing the website, and provide the call-login phone number received through the service server 300 to the user terminal 100.

The service server 300 checks whether the corresponding website is an additional authentication request site, and in a case where the corresponding website includes sensitive information such as financial information, an additional authentication procedure may be required (S103).

The service server 300 may transmit a randomly generated call-login phone number to the user terminal 100; however, when additional authentication is required, the service server 300 may generate and transmit a call-login phone number of a specific band (S105, S107).

The user terminal 100 makes a call to the call-login phone number provided by the service server 300 (S109), and when receiving a request for additional authentication, the call system 200 may prompt the user terminal 100 to input additional authentication information. For example, the call system 200 may request an input of a preset password or request an input of voice information for speaker recognition. In this case, the call system 200 distinguishes call-login phone number bands, and when receiving a call-login phone number of a specific number band, it may prompt the corresponding user terminal 100 to input additional authentication information (S111).

When the requested information is input at the user terminal 100 and the corresponding information is transmitted to the call system 200 (S113, S115), the call system 200 may transmit the received authentication information, the terminal phone number of the user terminal 100, and the received call-login phone number to the service server 300 (S117).

The service server 300 may check the received authentication information and stored authentication information for each user to verify whether the corresponding user is authenticated (S119)

In addition, the service server 300 checks whether there is a call-login number issued that is identical to the call-login phone number transmitted by the call system 200, and if the identical number exists, the service server 300 may request a login to the content server 400 providing the corresponding website while transmitting access information including the phone number of the user terminal 100 and/or the IP address of the user terminal 100 (S121 and S123).

In this case, when an additional authentication procedure is not required, the call system 200 may immediately transmit the phone number of the calling user terminal 100 and the received call-login phone number to the service server 300; and if there is a call-login number issued that is identical to the call-login phone number transmitted by the call system 200, the service server 300 may request a login for the user terminal 100 by transmitting access information including the phone number and/or the IP address of the corresponding user terminal 100 to the content server 400 providing the corresponding website.

In addition, as described above, when verifying a user, a timer may be applied so that the system can be designed to enhance security by processing a login request only when a call is made to a call-login number generated within a specific time.

The content server 400 may proceed with a web page login process for the user terminal 100 through the received access information of the user terminal 100 and provide the corresponding web page (S125 and S127), and may verify membership registration status through the received phone number of the user terminal 100.

In this case, if the user is not a member, as described above, the content server 400 may generate a user ID based on the received phone number of the user terminal 100 and proceed with membership registration through only a basic agreement procedure regarding terms of service, or may proceed with membership registration by causing a user ID based on the phone number of the user terminal to be generated by the service server 300.

When the call between the call system 200 and the user terminal 100 is terminated (S129), the call system 200 notifies the service server 300 of the call termination while transmitting the phone number of the corresponding user terminal 100 (S131), and the service server 300 requests a logout while transmitting access information of the corresponding user terminal 100 to the content server 400 (S133), such that the content server 400 may execute the logout (S135).

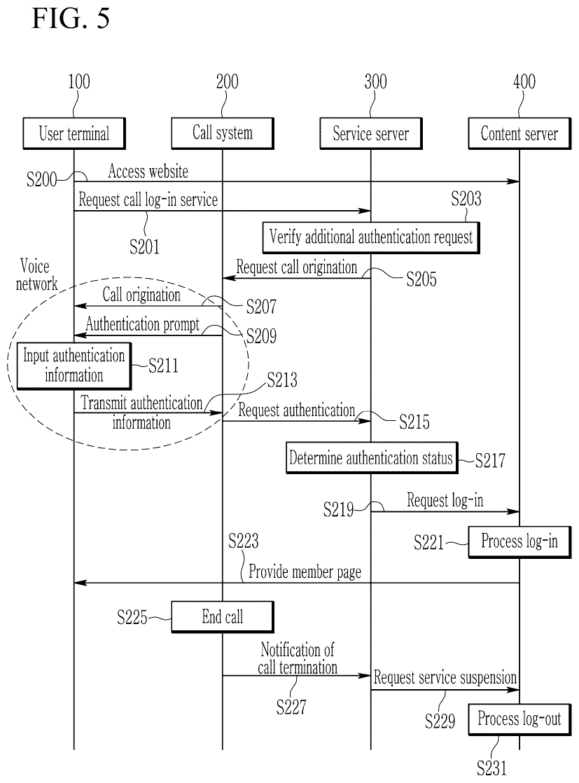

FIG. 5 illustrates an embodiment describing a flow in which a user accesses a website through a mobile terminal and then receives a call initiated by the service server 300 to log in to the corresponding site, wherein portions overlapping with the above-described contents will be omitted or briefly described.

First, the user terminal 100 may access a website provided by the content server 400 (S200).

The content server 400 may provide a “Call-Login” menu, which is a login method utilizing a phone call among login methods; and upon selection of the Call-Login menu, the content server 400 may provide an input window for a phone number of the user terminal 100, such that the user terminal 100 provides the phone number of the user terminal 100 and access information to the service server 300 to request a Call-Login service (S201).

The service server 300 may verify whether the corresponding website is a site requiring additional authentication, and may request the call system 200 to initiate a call to the received phone number of the user terminal 100. In this case, when additional authentication is required, the service server 300 may make a request for additional authentication to the call system 200 (S203 and S205).

The call system 200 makes a call to the received phone number, and when additional authentication is required, it may prompt the user terminal 100 for additional authentication (S207 and S209).

When the requested information is input and transmitted by the user terminal 100 (S211 and S213), the call system 200 may transmit the received authentication information and the phone number of the user terminal 100 to the service server 300. In addition, as described above, when additional authentication is not required, the call system 200 may verify only the phone number of the user terminal 100 without prompting for additional authentication and transmit the phone number to the service server 300 (S215).

The service server 300 may determine whether the corresponding user is authenticated by checking the received authentication information and stored authentication information for each user, and when additional authentication is not required, the service server 300 may verify only the phone number and request login processing by transmitting the terminal phone number of the corresponding user and website access information of the user to the content server 400 (S217 and S219).

The content server 400 may proceed with a web page login process for the user terminal 100 through the received access information of the user terminal 100 and provide the corresponding web page; and as described above, it is possible to verify membership registration status or proceed with membership registration through the received phone number of the user terminal 100 (S221 and S223).

When the call between the call system 200 and the user terminal 100 is terminated (S225), the call system 200 notifies the service server 300 of the call termination (S227), and the content server 400 may execute logout processing at the request of the service server 300 (S229 and S231).

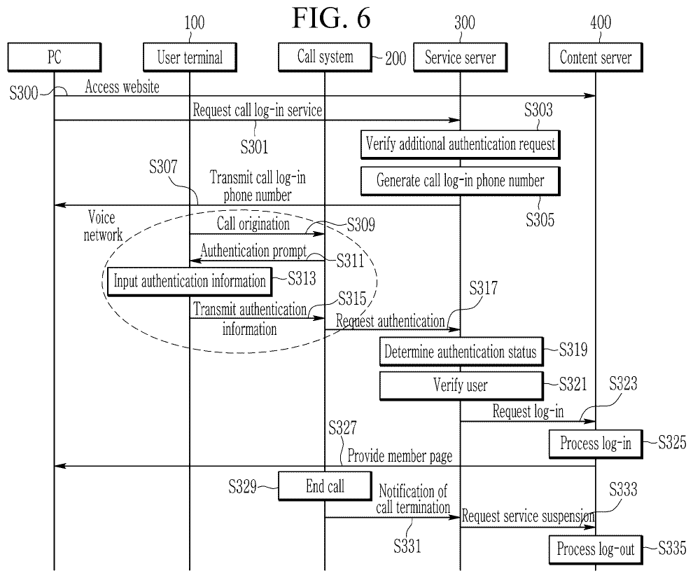

FIG. 6 illustrates an embodiment describing a flow in which a user accesses a website through a PC and then makes a call to a call-login phone number through the user terminal 100 to log in to the corresponding site after authentication, wherein portions overlapping with the above-described contents will be omitted or briefly described.

The user accesses a website provided by the content server 400 through a PC, selects a “Call-Login” menu among login methods provided on the website, and may request a Call-Login service to the service server 300 while transmitting access information (S300 and S301). Alternatively, when the user terminal 100 accesses the website, the content server 400 may immediately request the Call-Login service to the service server 300.

In this case, even if the user does not separately select a call-login menu, the content server 400 may request a call-login service simultaneously with the user terminal 100 accessing a website, and provide a call-login telephone number received via the service server 300 to the user terminal 100.

The service server 300 determines whether the corresponding website is an additional authentication request site, and may transmit the generated call-login telephone number to the user's PC (S303, S305, and S307).

When the user places a call to the call-login telephone number through the user terminal 100 (S309), the call system 200 receives the call and may provide additional authentication guidance if necessary (S309 and S311).

When the user inputs the requested authentication information (S313), the call system 200 may transmit the received authentication information, the telephone number of the calling user terminal 100, and the received call-login telephone number to the service server 300 to request authentication (S315 and S317).

The service server 300 verifies the authentication of the corresponding user by checking the received authentication information against stored authentication information for each user, checks whether there is a call-login number issued that is identical to the received call-login telephone number, and may transmit the telephone number of the user terminal that called the identical call-login number and access information via the PC to the content server 400 providing the corresponding website to request a login (S319, S321, and S323).

In this case, as described above, if additional authentication is not required, the process of providing guidance for additional authentication and transmitting the corresponding authentication information is omitted.

The content server 400 may process a web page login through the user's PC and provide the corresponding web page; and when the call between the call system 200 and the user terminal 100 is terminated (S329), the call system 200 and the service server 300 may sequentially transmit call termination and the user telephone number and/or access information, respectively, to the content server 400 to cause a logout to be processed (S331, S333, and S335).

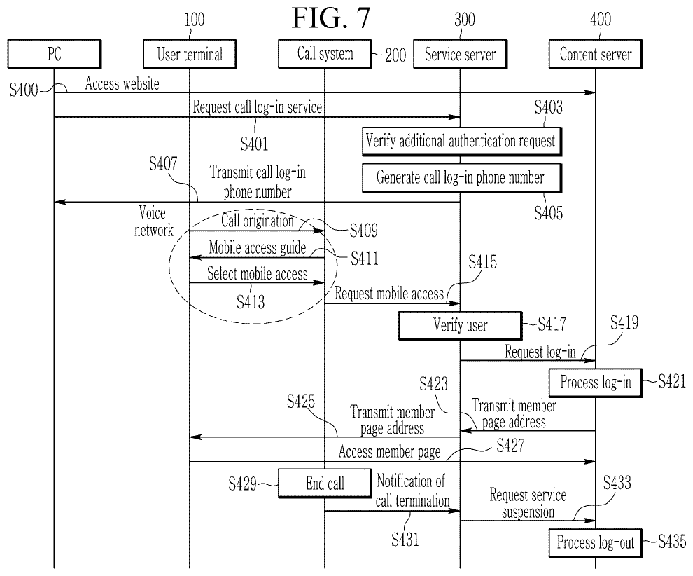

FIG. 7 illustrates, as an embodiment, a flow of accessing a website through the user terminal 100, which is a mobile terminal, after accessing a web page via a PC and performing user authentication using a call-login telephone number, wherein descriptions of parts overlapping with the above-described content are omitted or briefly described.

First, a user accesses a website through a PC (S400), selects a “call-login” menu from among login methods provided by the website, and may request a call-login service from the service server 300 together with transmitting access information (S400 and S401).

The service server 300 determines whether the corresponding website is an additional authentication request site, and may transmit the generated call-login telephone number to the user's PC (S403, S405, and S407).

When a user places a call to a call-login phone number through the user terminal 100, which is a mobile terminal (S409), the call system 200 receives the call and, if necessary, may provide additional authentication guidance as in the above-described embodiments

At this time, the call system 200 may provide guidance on mobile access to the user terminal 100 and inquire about the user's selection (S411).

When mobile access is selected by the user terminal 100, the call system 200 may transmit a mobile access request to the service server 300 together with the received authentication information, the phone number of the calling user terminal 100, and the received call-login phone number (S413 and S415), and the service server 300 may verify the corresponding user and request web page login processing from the content server 400 while transmitting the phone number of the user terminal 100 and access information (S417 and S419).

The content server 400 processes the web page login of the user and may transmit a web page address to the user terminal 100 through the service server 300 (S421, S423, and S425), and the user terminal 100 may access the received address and use the corresponding content (S427).

The call system 200 notifies the service server 300 upon termination of a call with the user terminal 100, and the service server 300 transmits the phone number and/or access information of the corresponding user terminal to the content server 400 to perform logout processing (S429, S431, S433, and S435).

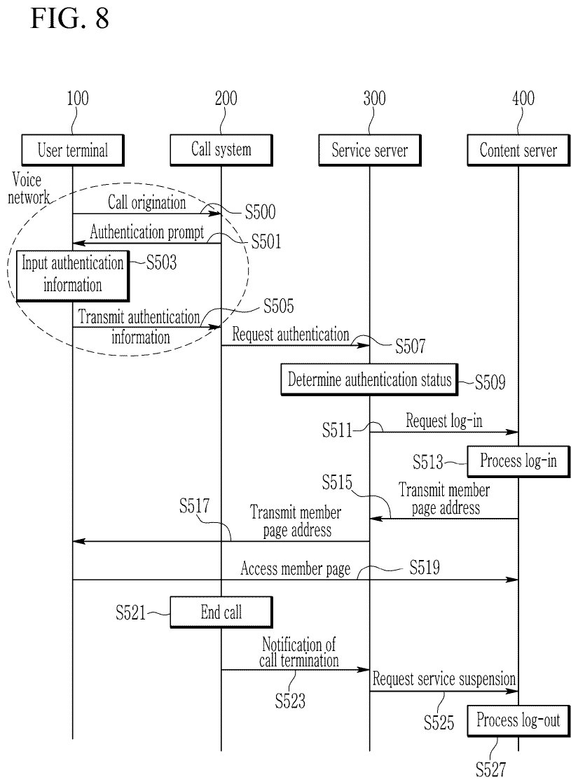

FIG. 8 describes a flow in which a user places a call to a pre-assigned call-login phone number to perform authentication and access a content server according to an embodiment, and descriptions overlapping with the above-described content will be omitted or briefly described.

First, the user terminal 100 may place a call to the call system 200 using a pre-assigned call-login phone number (S500). For example, a call-login phone number may be assigned to a corresponding company in advance to enable easy access to a website provided by the content server 400.

The call system 200 receives a call from the user terminal 100 and, if necessary, may provide additional authentication guidance (S501), and may receive necessary authentication information from the user terminal 100 (S503 and S505). At this time, as described above, the call system 200 may, for example, distinguish call-login phone number ranges and provide additional authentication guidance for a call in a specific number range.

The call system 200 transmits the phone number of the calling user terminal 100 and the received call-login phone number together with the received authentication information to the service server 300 to request authentication (S507), and as described above, when additional authentication is not required, the call system 200 may transmit only the calling terminal phone number and the received call-login phone number so that a login request is performed only through verification of the phone number of the user terminal 100.

The service server 300 determines whether the corresponding user is authenticated by verifying the received authentication information and pre-stored authentication information for each user, and may verify whether the received call-login phone number is a number assigned to a company registered in the call-login service by looking up the received call-login phone number (S509).

In the case where it is a service target, the service server 300 transmits the phone number of the user terminal 100 to the corresponding content server 400 to request a login (S511), and the content server 400 may transmit a web page address after performing login processing for a member web page where the corresponding user is registered as a member based on the received phone number of the terminal (S513 and S515).

The user terminal 100 accesses the address received through the content server 400 and the service server 300 to use registered content (S517 and S519), and the call system 200 transmits the phone number of the user terminal 100 to the service server 300 upon termination of a call with the user terminal 100 to cause the content server 400 to perform logout processing for the corresponding user (S521, S523, S525, and S527).

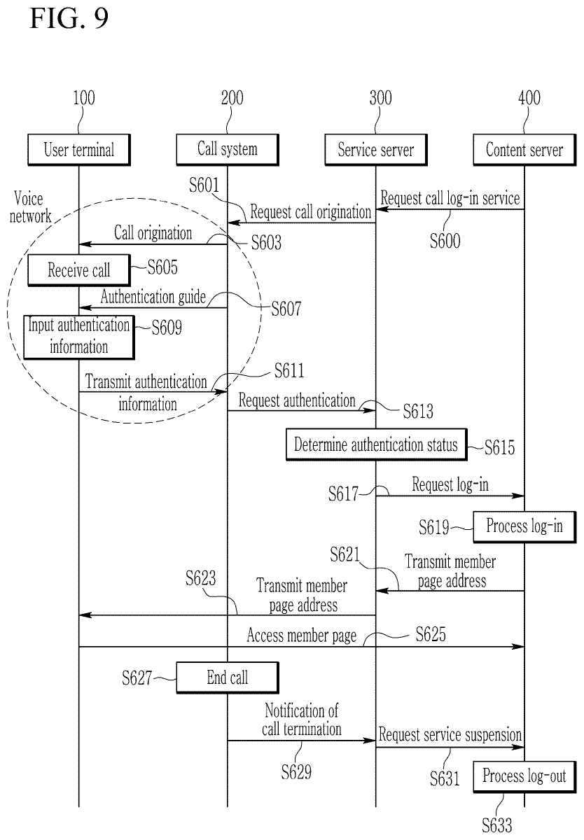

FIG. 9 describes a flow in which login processing and website access are performed when a call is placed to the user terminal 100 at the request of a company subscribed to the service and the call is connected, according to an embodiment, and descriptions overlapping with the above-described content will be omitted or briefly described.

First, the service server 300 may request the call system 200 to place a call to the received phone number of the user terminal 100 according to a call-login service request (S600 and S601).

When the call system 200 places a call to the corresponding phone number (S603) and the user terminal 100 receives the call (S605), the call system 200 may provide additional authentication guidance, such as requesting a password from the user or requesting input of voice information for speaker recognition (S607), and may transmit authentication information input from the user terminal 100 to the service server 300 (S609, S611, and S613).

The service server 300 may determine whether the corresponding user is authenticated by verifying the received authentication information and stored authentication information for each user, and may request a login by transmitting the phone number of the user terminal 100 to the content server 400 that requested a call-login call to the phone number of the user terminal 100 (S615 and S617).

The content server 400 may verify whether the corresponding user is a member based on the phone number of the user terminal 100 and process a website login (S619).

The content server 400 transmits a web page address through the service server 300 to the user terminal 100 for which login has been processed and access is enabled, and the user terminal 100 may access the address and use the corresponding content (S621, S623, and S625).

The call system 200 notifies the service server 300 upon termination of a call with the user terminal 100, and the content server 400 may perform logout processing for the corresponding user terminal 100 at the request of the service server 300 (S627, S629, S631, and S633).

As described above, according to the present invention, in a telephone-based communication environment, a caller and a callee are connected by a line through a voice network of a carrier. In this case, since the connected call line interconnects a calling terminal and a receiving terminal using phone numbers as unique IDs, a terminal connected to the call may be identified using a phone number verified through the call system 200. In this case, since the telephone-based voice network of a carrier operates in a closed environment, hacking by a third party is not easy.

Accordingly, by verifying the phone number of the user terminal 100 connected via a call and enabling the phone number to be used as a user ID for website login, the content server 400 may verify whether the user is a member based on the phone number of the user terminal 100 and perform login processing.

As a result, complex login procedures upon accessing a website are eliminated, and a login can be performed simply using only a phone number, thereby reducing authentication service costs incurred due to loss of IDs and passwords.

In addition, a user ID is automatically generated based on the phone number of the user terminal verified by a call placed by the user to proceed with membership registration, thereby enabling easy membership registration without creating an ID and password. Accordingly, complex membership registration and login procedures are simplified, enabling more users to use member content, thereby increasing content utilization.

In particular, by allowing the use of content only while the user terminal is connected to the call system via a call, it is possible to prevent a third party from abnormally attempting to log in to a member page of the corresponding user or access a web page in an abnormal situation where the user terminal is not connected to the call system via a call. Even if a third party logs in to a specific site using the user terminal, since access to a member page is possible only while a call is connected, this is inevitably recognized through a subsequent check of call records of the user.

The above-described embodiments may be implemented in the form of a computer program executable on a computer through various components, and such a computer program may be recorded on a computer-readable medium. In this case, the medium may include magnetic media such as hard disks, floppy disks, and magnetic tapes, optical recording media such as CD-ROMs and DVDs, magneto-optical media such as floptical disks, and hardware devices specially configured to store and execute program instructions, such as ROM, RAM, flash memory, and the like.

Unless the order is explicitly described or there is a description to the contrary regarding the steps constituting the method according to an embodiment of the present invention, the steps may be performed in an appropriate order. The present invention is not necessarily limited to the described order of the steps. The use of all examples or exemplary terms (e.g., etc.) in the present invention is merely for the purpose of describing the present invention in detail, and the scope of the present invention is not limited thereby. In addition, those skilled in the art will appreciate that various modifications, combinations, and changes may be made within the scope of the claims or equivalents thereof.

Although the embodiments of the present disclosure have been described in detail above, the scope of the present disclosure is not limited thereto, and various modifications and improvements made by those skilled in the art using the basic concept of the present disclosure defined in the following claims also fall within the scope of the present disclosure.

### DESCRIPTION OF REFERENCE NUMERALS

10: Authentication system
100: User terminal
200: Call system
210: Call reception unit
230: Authentication and connection management unit
240: Mobile access management unit
300: Service server
310: Authentication unit
320: Service management unit
400: Content server

1. An authentication method of a system for using content provided by a content server, the method comprising:
receiving a call log-in request from a user terminal;
transmitting a call log-in phone number to the user terminal;
receiving an outgoing call from the user terminal using the call log-in phone number to establish a call connection, and requesting log-in processing for the user terminal for the use of the content when the received call log-in phone number matches the transmitted call log-in phone number; and
allowing the user to use target content from the content server only in a state where the call connection is maintained after the log-in of the user terminal
and requesting log-out processing for the user terminal when the call connection is terminated.

2. The method of claim 1, further comprising:
after requesting the log-in processing,
verifying whether the user is a member based on a phone number of the user terminal; and
providing a member page to the user terminal if the user is the member.

3. The method of claim 1, further comprising:
processing member registration by generating a user ID based on a phone number of the user terminal, if the user is not a member as a result of verifying membership regarding the request for the log-in processing.

4. The method of claim 1, further comprising:
after the call connection,
guiding the user terminal to input additional authentication information; and
authenticating by comparing authentication information input from the user terminal with pre-stored user-specific authentication information.

5. An authentication method of a system for using content provided by a content server, the method comprising:
receiving a call log-in request together with a phone number of a user terminal;
originating a call to the user terminal using the phone number to establish a call connection;
requesting log-in processing for the user terminal for the use of the content; and
allowing the user to use target content from the content server only in a state where the call connection is maintained after the log-in of the user terminal, and requesting log-out processing for the user terminal when the call connection is terminated.

6. The method of claim 5, further comprising:
after requesting the log-in processing,
verifying whether the user is a member based on a phone number of the user terminal; and providing a member page to the user terminal if the user is the member.

7. The method of claim 5, further comprising:
processing member registration by generating a user ID based on a phone number of the user terminal, if the user is not a member as a result of verifying membership regarding the request for the log-in processing.

8. The method of claim 5, further comprising:
after the call connection,
guiding the user terminal to input additional authentication information; and
authenticating by comparing authentication information input from the user terminal with pre-stored user-specific authentication information.

9. An authentication method of a system for using content provided by a content server, the method comprising:
receiving a call log-in request from a PC;
transmitting a call log-in phone number to the PC;
receiving an outgoing call from a user terminal using the call log-in phone number to establish a call connection, and requesting log-in processing for the PC for the use of the content when the received call log-in phone number matches the transmitted call log-in phone number; and
allowing the user to use target content from the content server only in a state where the call connection is maintained after the log-in of the PC, and requesting log-out processing for the PC when the call connection is terminated.

10. The method of claim 9, further comprising:
after the call connection,
guiding the user terminal to input additional authentication information; and
authenticating by comparing authentication information input from the user terminal with pre-stored user-specific authentication information.

11. The method of claim 9, further comprising:
after the call connection,
providing a mobile access guide for the use of the content to the user terminal; and
requesting mobile access log-in processing for the user terminal, if the mobile access is selected by the user terminal and the received call log-in phone number matches the call log-in phone number.

12. The method of claim 11, further comprising:
after requesting the mobile access log-in processing,
allowing the user to use target content from the content server only in a state where the call connection is maintained, and requesting log-out processing for the user terminal when the call connection is terminated.

13. An authentication method of a system for using content provided by a content server, the method comprising:
receiving an outgoing call using a pre-issued call log-in phone number from a user terminal to establish a call connection;
requesting log-in processing for the user terminal when the received call log-in phone number matches the pre-issued and registered call log-in phone number; and
allowing the user to use target content from the content server only in a state where the call connection is maintained after the log-in of the user terminal, and requesting log-out processing for the user terminal when the call connection is terminated.

14. An authentication system for using content provided by a content server, the system comprising:
a call system configured to receive an outgoing call from a user terminal using a call log-in phone number to establish a call connection with the user terminal, and transmit a phone number of the user terminal and the call log-in phone number to a service server; and
a service server configured to generate a call log-in phone number and transmit the call log-in phone number to the user terminal upon a call log-in request from the user terminal, request log-in processing for the user terminal for the use of the content when the call log-in phone number received from the call system matches the call log-in phone number transmitted to the user terminal, allow the user to use target content from the content server only in a state where the call connection is maintained after the log-in of the user terminal, and request log-out processing for the user terminal when the call connection is terminated.

15. The system of claim 14
wherein the service server is configured to process member registration by generating a user ID based on a phone number of the user terminal, if the user is not a member as a result of verifying membership regarding the request for the log-in processing.

16. The system of claim 14,
wherein the call system is configured to guide input of additional authentication information and receive the additional authentication information from the user terminal, when receiving an outgoing call using a call log-in phone number in a specific band from the user terminal; and
wherein the service server is configured to authenticate by comparing the additional authentication information received from the call system with pre-stored user-specific authentication information.

17. An authentication system for using content provided by a content server, the system comprising:
a call system configured to originate a call to a phone number of a user terminal received from a service server, and transmit the phone number of the user terminal upon call connection; and
a service server configured to request the call system to originate the call to the user terminal, request log-in processing for the user terminal for the use of the content upon the call connection, allow the user to use target content from the content server only in a state where the call connection is maintained after the log-in of the user terminal, and request log-out processing for the user terminal when the call connection is terminated.

18. An authentication system for using content provided by a content server, the system comprising:
a call system configured to receive an outgoing call from a user terminal using a call log-in phone number to establish a call connection with the user terminal, and transmit a phone number of the user terminal and the call log-in phone number to a service server; and
a service server configured to generate a call log-in phone number and transmit the call log-in phone number to a PC upon a call log-in request using the PC, request log-in processing for the PC for the use of the content when the call log-in phone number received from the call system matches the call log-in phone number transmitted to the PC, allow the user to use target content from the content server only in a state where the call connection is maintained after the log-in of the PC, and request log-out processing for the PC when the call connection is terminated.

19. The system of claim 18,
wherein the call system is configured to provide a mobile access guide for the use of the content to the user terminal after the call connection; and
wherein the service server is configured to request log-in processing for the user terminal when receiving a selection of mobile access from the call system, allow the user to use target content from the content server only in a state where the call connection is maintained after the log-in of the user terminal, and request log-out processing for the user terminal when the call connection is terminated.

20. A service server for providing an authentication service through a user terminal for use of content provided by a content server, the service server comprising:
an authentication unit configured to generate a call log-in phone number and transmit the call log-in phone number to the user terminal upon a call log-in request, thereby enabling the user terminal to originate a call to the call log-in phone number; and
a service management unit configured to request log-in processing for the user terminal for the use of the content when a call connection is established through an outgoing call from the user terminal and the received call log-in phone number matches the call log-in phone number transmitted by the authentication unit, allow the user to use target content from the content server only in a state where the call connection is maintained after the log-in of the user terminal, and request log-out processing for the user terminal when the call connection is terminated.

21. The service server of claim 20,
wherein the service management unit is configured to process member registration by generating a user ID based on a phone number of the user terminal, if the user is not a member as a result of the request for the log-in processing.

22. The service server of claim 20,
wherein the authentication unit is configured to transmit the call log-in phone number to the PC when the call log-in request is received through a user PC; and
wherein the service management unit is configured to request log-in processing for the PC for the use of the content when a call connection is established through an outgoing call from the user terminal and the received call log-in phone number matches the call log-in phone number transmitted by the authentication unit, allow the user to use target content from the content server only in a state where the call connection is maintained after the log-in of the PC, and request log-out processing for the PC when the call connection with the user terminal is terminated.

23. The service server of claim 22,
wherein the service management unit is configured to request log-in processing for the user terminal when receiving a selection of mobile access of the user terminal, in a case where a call connection is established through an outgoing call from the user terminal upon receiving a call log-in request from a PC and the received call log-in phone number matches the call log-in phone number transmitted by the authentication unit; allow the user to use target content from the content server only in a state where the call connection is maintained after the log-in of the user terminal; and request log-out processing for the user terminal when the call connection with the user terminal is terminated.

24. A service server for providing an authentication service through a user terminal for use of content provided by a content server, the service server comprising:
an authentication unit configured to receive a call log-in request together with a phone number of the user terminal, and cause a call to be originated to the phone number of the user terminal to establish a call connection; and
a service management unit configured to request log-in processing for the user terminal for the use of the content upon the call connection, allow the user to use target content from the content server only in a state where the call connection is maintained after the log-in of the user terminal, and request log-out processing for the user terminal when the call connection is terminated.
